(19) United States
(12) Patent Application Publication
(10) Pub. No.: US 2025/0298605 A1
(43) Pub. Date: Sep. 25, 2025

(54) CHANGE ANALYSIS FOR APPLICATION DEPLOYMENT

(71) Applicant: DISH Network Technologies India Private Limited, Bengaluru (IN)

(72) Inventors: Yogesh Malhotra, Bangalore (IN); Praveen Kumar Nadipi Karunakara, Bangalore (IN); Vedam Jude Pragash, Bangalore (IN); Shishir Pandey, Secunderabad (IN)

(21) Appl. No.: 19/085,847

(22) Filed: Mar. 20, 2025

(30) Foreign Application Priority Data
Mar. 20, 2024 (IN) 202441021200

(51) Int. Cl. G06F 8/65

(52) U.S. Cl. CPC G06F 8/65

(57) ABSTRACT

Systems, devices, and methods related to change analysis for application deployment are provided. An example method performed by a computer system includes receiving a dependency graph associated with an application or an update to the application for deployment in a target environment. The dependency graph indicates resources within the target environment and dependency relationships among the resources. The method further includes identifying a change in resources caused by the application and one or more impact paths from the dependency graph. Each one of the impact paths indicates one or more changed resources associated with the application and one or more impacted resources originating from the one or more changed resources across the dependency graph. The method further includes generating a change impact summary indicating the one or more impact paths and outputting the change impact summary.

### CROSS REFERENCE TO RELATED APPLICATIONS

This application claims priority to Indian Provisional Patent Application No. 202441021200, titled “AUTOMATED GOVERNANCE AND COMPLIANCE GATING OF APPLICATION DEPLOYMENTS,” filed on Mar. 20, 2024, in the Indian Intellectual Property Office, the disclosure of which is incorporated by reference in its entirety for all purposes. This application is also related to U.S. patent application Ser. No. 18/958,696, filed on Nov. 25, 2024, titled “AUTOMATED GOVERNANCE AND COMPLIANCE GATING OF APPLICATION DEPLOYMENTS,” Attorney Docket No. P2024-05-02 (1446931), filed concurrently, titled “AUTOMATED DEPENDENCY MANAGEMENT FOR APPLICATION DEPLOYMENT,” and Attorney Docket No. P2024-05-03 (1446932), filed concurrently, titled “NATURAL LANGUAGE INTERFACE,” the disclosures of which are incorporated by reference in their entirety for all purposes.

### BACKGROUND

Deployment of a software application typically involves a sequential and multi-stage process, where the software application is released and updated through a step-by-step procedure. Conventional methods for software deployment often follows a linear trajectory, starting with building and development, progressing through validation and testing, and ultimately reaching production deployment. Developers and operations teams are involved in each stage and manage tasks such as code compilation, testing, configuration, and release. A common example of the conventional method is the use of manual deployment scripts or runbooks, where operators execute a series of predefined steps to deploy the software to production servers. However, this conventional method is prone to drawbacks and limitations. Manual interventions can lead to human errors and result in deployment inconsistencies across different environments. In addition, the process tends to be time-consuming and may cause downtime as updates are implemented. Further, the manual deployment process lacks automated decision-making and can hinder agility and scalability.

### BRIEF SUMMARY OF THE DISCLOSURE

The present disclosure provides systems, devices, and methods related to change analysis. In one example, a computer-implemented method includes receiving a dependency graph associated with an application or an update to the application for deployment in a target environment. The dependency graph indicates resources within the target environment and dependency relationships among the resources. The method further includes identifying a change in resources caused by the application and one or more impact paths from the dependency graph. Each one of the impact paths indicates one or more changed resources associated with the application and one or more impacted resources originating from the one or more changed resources across the dependency graph. The method further includes generating a change impact summary indicating the one or more impact paths and outputting the change impact summary.

In another example, a computer system includes one or more processors and a computer-readable storage media storing computer-executable instructions, wherein, the instructions when executed by the one or more processors, cause the computer system to perform a method described in the present disclosure.

In accordance with some embodiments, the present disclosure also provides a non-transitory machine-readable storage medium encoded with instructions, the instructions executable to cause one or more electronic processors of a media device to perform any one of the methods described in the present disclosure.

### BRIEF DESCRIPTION OF THE DRAWINGS

FIG. 1 is a block diagram illustrating an example communications system for automated deployment of applications, according to various embodiments of the present disclosure.

FIG. 2A is a block diagram illustrating an example of the change analysis system shown in FIG. 1, according to various embodiments of the present disclosure.

FIG. 2B is a block diagram illustrating interactions among the components of the change analysis system shown in FIG. 2A as well as interactions between the change analysis system of FIG. 2A and components in the communication system shown in FIG. 1, according to various embodiments of the present disclosure.

FIG. 3 is a flow message diagram illustrating interactions among components of the change analysis system shown in FIGS. 2A and 2B, according to various embodiments of the present disclosure.

FIG. 4A is a flow diagram illustrating an example method for change analysis, according to various embodiments of the present disclosure.

FIG. 4B is a flow diagram illustrating one process block of the method illustrated in FIG. 4B, according to various embodiments of the present disclosure.

FIG. 4C is a flow diagram illustrating another process block of the method illustrated in FIG. 4B, according to various embodiments of the present disclosure.

FIG. 5 is a block diagram illustrating an example computer system or computer device, according to various embodiments of the present disclosure.

### DETAILED DESCRIPTION OF THE DISCLOSURE

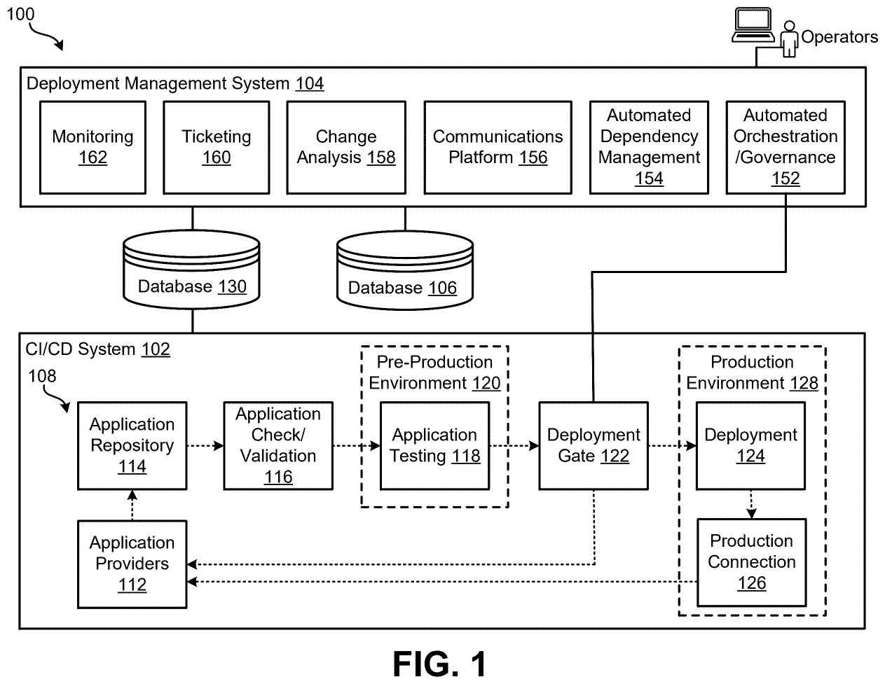

FIG. 1 is a block diagram illustrating an example communications system 100 for deployment of software applications (hereinafter “applications”) in a software application development environment. In the illustrated example, communications system 100 includes, among other components, a continuous integration/continuous deployment system 102 (hereinafter “CI/CD system 102”), a deployment management system 104, and a database 106. Each component included in the communications system 100 may be a hardware component, a software component, or a combination of both hardware and software. Additional or fewer components may be included in the communications system 100. The CI/CD system 102 is generally responsible for deployment of applications through CI/CD pipeline execution. The deployment management system 104 is in communication with the CI/CD system 102 and is operable to allow operators to manage the deployment process of an application through execution of a CI/CD pipeline for the application, monitor the status of CI/CD pipeline execution of a software application, access various application data sources from database 130, determine whether the software application is ready for release, and control block or release of the application through a deployment gate 122 of the CI/CD system. In some embodiments, the deployment management system 104 may be integrated with the CI/CD system 102 to form a single system that includes the components of both.

The CI/CD system 102 further includes, among other components, application providers 112, application inventory 114 (also referred to as “application inventory”), application check and validation system 116, application testing system 118, deployment gate 122, deployment execution system 124, production connections 126, and database 130. Application providers 112 are entities or services that supply the necessary application packages, application artifacts, codes, application configuration data, service applications, docker images, dependencies, or updates of applications to the CI/CD system 102. Application providers 112 may also supply external libraries, third-party components, or internal dependencies for the development and deployment process. In some embodiments, application provider 112 may be an individual software vendor (ISV). In some embodiments, the CI/CD system 102 is automatically triggered to initiate execution of a CI/CD pipeline 108 for deployment of an application upon receiving a request for deploying the application or a request for a change/update/modification to an application.

The application inventory 114 is a centralized storage system where source codes, artifacts, and other relevant files are stored, classified, organized, and maintained. In some embodiments, the application inventory 114 serves as a version-controlled repository and is configured to track, monitor, manage, and update changes to the application codes and make the application codes accessible to the CI/CD system 102 and any components thereof for automated integration and deployment. Version data of the application and any components thereof may be stored in database 130.

The application check validation system 116 is generally responsible for conducting checks, verifications, and validations on the application artifacts before they progress further in the CI/CD pipeline 108. The application check validation system 116 may further include various modules such as code quality assessment module, security scan module, security check module, sentinel check module, dependency check module, environment lock module, metrics and reports module, among others.

For example, the code quality assessment module may be configured to utilize static code analysis tools to evaluate the overall quality of the application artifact according to predetermined standards for maintainability, readability, and adherence to coding standards. The security scan module is configured to conduct security scans on the codebase of the application artifact to identify vulnerabilities, potential exploits, and adherence to security best practices, based on predetermined standards. The security check module is configured to check the security-related aspects of the codebase, including authentication mechanisms, encryption protocols, and secure coding protocols. The sentinel check module is configured to implement automated validation routines or scripts to assess whether the predefined conditions or criteria are met before allowing the application artifacts to proceed further in the CI/CD pipeline 108.

The dependency check module is configured to check and validate dependencies within an application. Dependencies may include external libraries, frameworks, modules, or other components on which the application relies. In some embodiments, the dependency check module is configured to analyze the dependencies declared or utilized by the application, verify the compatibility of the dependencies with a target environment, check whether the dependencies of the application conform to version requirements, check whether the dependencies adhere to licensing requirements and organizational policies, check the overall health of dependencies. The dependency check module may generate output with outcomes of the dependency check. Dependency data of an application is stored in database 130. Directed dependency graphs generated from the dependency data are also stored in database 130.

The environment lock module is generally responsible for managing and enforcing locks on different environments during the deployment process. The environment lock module may be configured to identify different deployment environments, such as development, testing, and production, where application artifacts move through the CI/CD pipeline 108, implement a locking mechanism that can be applied to each environment individually, support time-based locks to allow the definition of specific time intervals during which an environment is locked, and monitors the status of environment locks in real-time. Environment lock data is stored in database 130.

The metrics and reports module is generally responsible for collecting, analyzing, and presenting relevant metrics and reports related to the deployment process through the CI/CD pipeline 108. The metrics and reports module may be configured to collect various data and output reports from other components within CI/CD system 102, define and track metrics that are aligned with predetermined criteria, utilizes automated analysis tools to process the collected data and derive insights, generate and manage reports based on the analyzed metrics, and present metrics and insights in a visually accessible format, such as charts, graphs, and dashboards. Performance metrics data is stored in database 130.

The application testing system 118 is generally responsible for testing the application artifacts in pre-production environment 120 before deployment in the production environment 128. The application testing system 118 may be configured to generate and configure testing environments, executing test instances of the application artifact in the configured testing environments, monitoring the testing, and generating outcome (e.g., testing report). A test environment used herein refers to a controlled and isolated setup that mimics the production environment to conduct application testing and validate the functionality, performance, and reliability of a software application. Execution of test instances includes the execution of a specific set of test cases designed to validate certain aspects of the application, such as functionality, performance, or security. Each test instance may be conducted in isolation to focus on a specific aspect of the application. Input data specific to a test environment may be used to simulate realistic conditions and interactions with the application. Expected outcomes may be determined based on the test case specifications, and the actual outcomes during execution may be compared against the expected outcome to determine whether the application passes the testing. Testing and validation data of an application is stored in database 130.

The deployment gate 122 is the final gate before deploying the application in the production environment 128. The deployment gate 122 is controlled by the deployment management system 104 to verify that the application has undergone required validation and testing, including but not limited to checking the validation status, checking for successful execution of test cases, meeting quality standards, and/or addressing any identified defects or deficiencies. The deployment gate 122 is further configured to execute an instruction to release or block release of the deployment based on determinations whether all predetermined requirements for deployment are met. These requirements may cover functional correctness, performance, security, reliability, and compliance with predetermined or pre-established policies and standards. If the application passes all validation and testing checks, and if all predetermined requirements are met, the deployment gate 122 allows the release of the application to the production environment 128. If any issues are identified during the validation process or if predetermined requirements are not met, the deployment gate 122 holds the release of the application.

In some embodiments, the deployment gate 122 is controlled by the deployment management system 104 to allow or hold the release of the application based on a release readiness score. A release readiness score used herein refers to a quantitative or semi-quantitative measure or numerical representation that assesses the overall readiness of an application release for deployment to a production environment. The release readiness score may be determined through evaluation of various factors, including the outcomes of validation and testing processes, adherence to predefined requirements, and other relevant criteria. The release readiness score may be determined by the deployment management system 104, based on various analytical data such as the outcomes of validation and testing or relevant reports, to calculate the release readiness score. For example, a threshold release readiness score may be established and used as a standard or reference, and only the application with a release readiness score of or above the threshold release readiness score may be released by the deployment gate 122 to the production environment 128.

The deployment execution system 124 is generally responsible for executing deployment instance of the application released to the production environment and exposing the application to production connections 126. The deployment execution system 124 may coordinate with production connections 126 to integrate the deployed application with other systems, services, and components within the production environment 128. The deployment execution system 124 may also configure the production environment 128 (e.g., update configuration files, adjust database settings, etc.) to accommodate the released application. The production environment is established on an infrastructure. In some embodiments, the production environment is established on a cloud-computing platform. The deployment execution system 124 provides various resources, such as infrastructure resources, platform resources, and application resources for deployment of the application.

The database 130 further includes various application data sources related to the to-be-deployed application and the data generated during the CI/CD pipeline execution of the application. For example, the database 130 may include SLI/SLO/SLA data, environment lock data, reliability index data, prime time data, security data, compliance data, and calculated compliance scores, among others. Service Level Indicators (SLIs) are specific metrics that quantify the performance of a service, such as latency, error rate, and throughput. Service Level Objectives (SLOs) are the target values or ranges for these indicators that define the expected level or quality of service performance for the to-be-deployed application. Environment lock data indicates the status of different environments (e.g., development, testing, staging, production) and whether they are currently locked or available for deployments. Reliability index data includes metrics related to the reliability and stability of the application, such as system uptime, failure rates, and mean time to recovery (MTTR). Prime time data includes information about critical periods when deployments are restricted to avoid disruptions, such as times of high user activity from historical analysis and predetermined critical times. Security data includes information from various security scans and assessments and identified vulnerabilities and threats within the application. Compliance data includes information related to regulatory and internal compliance requirements that the application must adhere to. The deployment management system 104 and various modules included therein may access the data from the database 130 and use the data to determine whether the application is ready for release.

In the illustrated example of FIG. 1, the deployment management system 104 may further include, among other components, an automated orchestration and governance system 152, an automated dependency management system 154, a communications platform or hub 156, a change/update analysis system 158, a ticketing system 160, and a deployment monitoring system 162.

At a high level, the automated orchestration and governance system 152 is generally responsible for coordination and control over the release and deployment processes to ensure smooth, reliable, and secure delivery of application. In some embodiments, the automated orchestration and governance system 152 is configured to receive validation and testing outcomes of the application through the CI/CD pipeline 108 and generated by the CI/CD system 102, analyze the validation and testing outcomes, and determine whether the application is ready to release (e.g., calculating the release readiness score). More details of the automated orchestration and governance system 152 is described in U.S. patent application Ser. No. 18/958,696, filed on Nov. 25, 2024, titled “AUTOMATED GOVERNANCE AND COMPLIANCE GATING OF APPLICATION DEPLOYMENTS,” the disclosure of which is incorporated herein by reference in its entirety.

At a high level, the automated dependency management system 154 is generally responsible for identifying changes in components within an application and assessing their impact on the entire application ecosystem, utilizing automated mechanisms to facilitate a dependency management process. In some embodiments, the changes are resource component changes, for example, infrastructure changes, platform changes, or application changes. The changes are not application code changes. More details of the communications platform 156 described in U.S. Patent Application with Attorney Docket No. P2024-05-02 (1446931), filed concurrently, titled “AUTOMATED DEPENDENCY MANAGEMENT FOR APPLICATION DEPLOYMENT,” the disclosure of which is incorporated herein by reference in its entirety.

At a high level, the communications platform 156 includes various interfaces for facilitating communications (e.g., message flow, data and file transfer, input, output, etc.) between the deployment management system 104 and the CI/CD system 102 as well as between the deployment management system 104 and operators. The communications platform 156 may include, among others, a natural language interface that provides a platform for the operators to query current and past states of the CI/CD system 102, obtain information about impact analysis of any changes or updates introduced by an application, and set up alerts and create periodic reports. More details of the communications platform 156 is described below with references to U.S. Patent Application with Attorney Docket No. P2024-05-03 (1446932), filed concurrently, titled “NATURAL LANGUAGE INTERFACE,” the disclosure of which is incorporated herein by reference in its entirety.

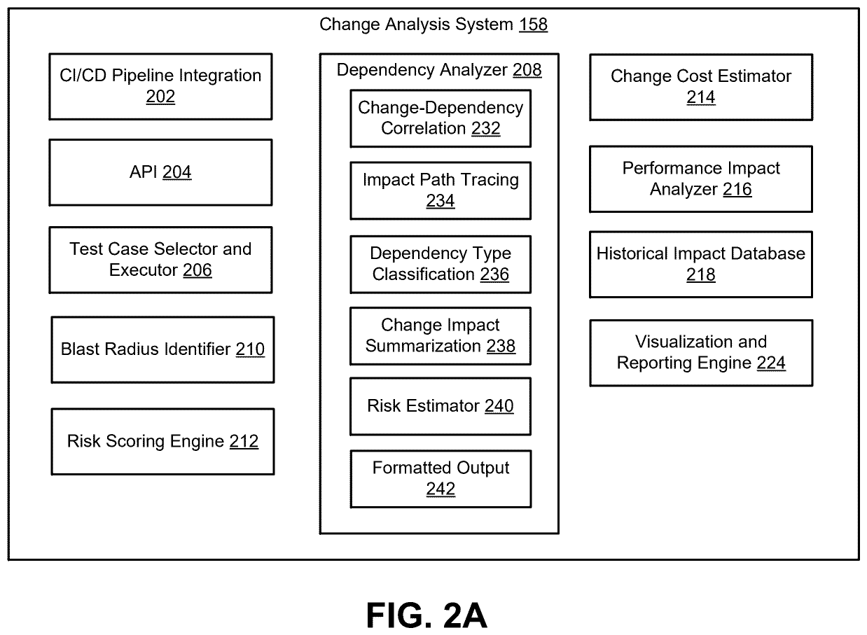

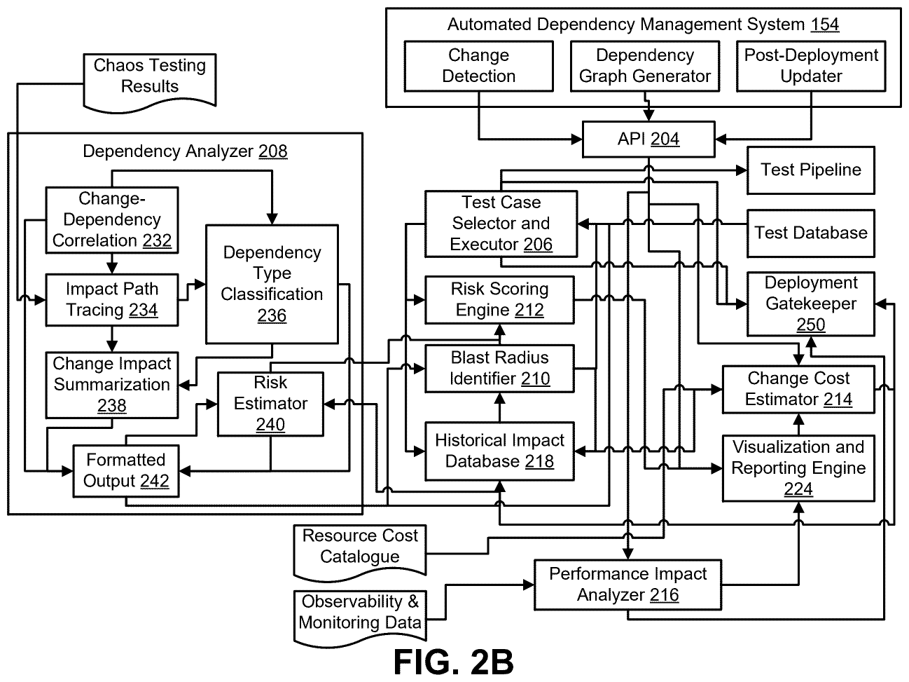

At a high level, the application change/update analysis system (i.e., change analysis system or change analyzer) 158 is generally responsible for analyzing and providing insights into the changes and updates made to the application and all dependent applications. The change analysis system 158 is generally configured to conduct change impact analysis, change cost analysis, resource optimization, and predictive modeling. The change analysis system 158 may be configured to incorporate advanced features for identifying, validating, and securing modified components within the application slated for deployment, determine the validations and tests required for deployment of a new application or update of an existing application as well as the validations and tests required for all dependent or impacted applications associated with the new application or update of the application. More details of the change analysis system 158 is described below with references to FIGS. 2A and 2B.

At a high level, the ticketing system 160 serves as a central platform and is generally responsible for managing and tracking various activities, requests, incidents and issues related to application changes and deployments. The deployment monitoring system 162 (i.e., monitoring system) is generally responsible for monitoring deployments in real-time and providing immediate visibility into the status and progress of each deployment, detecting errors or issues during the deployment process, generating deployment data (e.g., monitoring/logging/tracing (MELT) data), and tracking resources created for or allocated to the application, tracking dependencies between different components of the application as well as upstream and downstream applications.

The database 106 may include various databases for storing the data received in and generated by the CI/CD system 102 and the deployment management system 104. The database 106 may include a relational database service (RDS) for storing and retrieving structured data where relationships between different resources or data elements need to be maintained, a graph storage or database for storing dependency graph data, a vector database, a MELT database for storing and managing data related to metrics, events, logs, traces related to a specific application or a specific infrastructure, a documentation database for storing and managing code documentation, chaos testing results data, resource cost catalogue storing resource cost data (e.g., predetermined cost of various computing resources), observability and monitoring data, infrastructure documentation, and other relevant information, a reliability database for storing reliability score data for applications, a change analysis data base for change impact data, test case execution result data, risk score data, change cost estimate data, performance change data, among others.

FIG. 2A is a block diagram illustrating an example of the change analysis system 158 shown in FIG. 1. FIG. 2B is a block diagram illustrating interactions among the components of the change analysis system shown in FIG. 2A as well as interactions between the change analysis system of FIG. 2A and components in the communication system 100 shown in FIG. 1. The change analysis system 158 may be a computer system including various modular components. In the illustrated example of FIGS. 2A and 2B, the change analysis system 158 includes a CI/CD pipeline integration module 202, an application programming interface (API) 204, a test case selector and executor 206, a dependency analyzer 208, a blast radius identifier 210, a risk scoring engine 212, a change cost estimator 214, a performance impact analyzer 216, a historical impact database 218, and a visualization and reporting engine 224. The various engines, analyzers, identifiers, interfaces, and modules included in the change analysis system 158 may each be a hardware component, a software component, or a combination of both. Fewer or additional components may be included in the change analysis system 158. In some embodiments, the change analysis system 158 is integrated into the automated dependency management system 154. In some embodiments, the change analysis system 158 is integrated into the automated orchestration and governance system 152.

At a high level, the change analysis system 158 shown in FIGS. 2A and 2B is generally responsible for evaluating the potential effects and impacts of the change introduced by the new application or an update of an application within the application deployment environment. The change analysis system 158 is operable to utilize various data output by or derived from the automated dependency management system 154 to identify interrelationships among various components within an application and interrelationships between the components of the application and other components in the application deployment environment. Upon receiving a change or modification, the change analysis system 158 is operable to analyze the dependency graph generated by the automated dependency management system 154 to ascertain impacted components and evaluate associated ripple effects. The change analysis system 158 is operable to determine the severity and scope of identified impacts based on predefined parameters, including but not limited to, the criticality of impacted components, the quantity of impacted components, and historical impact data. The change analysis system 158 is operable to generate reports/outputs specifying direct and indirect impacts and risk assessments. The change analysis system 158 is further operable to define the scope of the analysis to the boundaries of a single change event, wherein a single change event may encompass changes in multiple resources and exclude the evaluation of interactions between multiple change events as well as temporal dimensions associated with change impacts.

Within the change analysis system 158, the CI/CD pipeline integration module 202 integrates the change analysis system with CI/CD system 102 and the CI/CD pipeline associated with the to-be-deployed new application or update of the application. The CI/CD pipeline integration module 202 can automate the deployment of code changes and infrastructure updates, integrate the change analysis workflow to the CI/CD pipeline, retrieve data and information from the database(s) in connection with the CI/CD system, and communicate with the deployment gate 122.

The API (or API layer) 204 within the change analysis system 158 is operable to facilitate seamless communication and data exchange between the various components of the change analysis system 158 and external components of the communications system 100. API 204 generally serves as an interface that allows automated dependency management system 154 (e.g., the change detection module, dependent graph generator, and post-deployment updater within the automated dependency management system 154), CI/CD pipelines, testing frameworks, or third-party services or tools, to interact with the change analysis system 158. In some embodiments, the API 204 is integrated to the CI/CD pipeline integration module 202.

Within the change analysis system 158, the dependency analyzer 208 is generally responsible for interpreting the intersection of dependency graphs and the identified changes to determine the potential impacts of a given change on interconnected resource components in the application deployment environment. The dependency analyzer 208 is operable to identify both direct and indirect dependencies, trace impact paths, and classify dependencies to provide a comprehensive understanding of how changes propagate through the deployment. The dependency analyzer 208 can utilize centrality measures and historical data to assess and prioritize risky resources and calculate overall risk scores for changes. The dependency analyzer 208 can also provide summaries and visualizations of change impacts and risk assessment, facilitate informed decision-making, and allow for seamless integration with other modules of the change analysis system 158.

In some embodiments, as illustrated in FIGS. 2A and 2B, the dependency analyzer 208 may further include a change-dependency correlation module 232, an impact path tracing module 234, a dependency type classification module 236, a change impact summarization module 238, a risk estimator 240, and a formatted output module 242.

The change-dependency correlation module 232 is operable to map changes identified by the change detection module of the automated dependency management system 154 onto the dependency graph generated by the dependency graph generator of the automated dependency management system 154. The change-dependency correlation module 232 is further operable to identify all resource components that are directly or indirectly connected to the changed components and provide a foundation for analyzing the scope and reach of the impact caused by the changes. Change-dependency correlation data may be generated by the change-dependency correlation module 232 and stored in a database connected to the change analysis system 158.

The impact path tracing module 234 is operable to identify the paths of impact introduced by a change across the dependency graph, identify and analyze strongly connected components (SCCs) within the dependency graph, and determine both the shortest and longest chains of impacted resource components (e.g., nodes or edges) based on the SCCs. For example, the impact path tracing module 234 can use centrality measures, such as degree, betweenness, and closeness centrality to prioritize risky nodes, assign impact weights to SCCs, and calculate impact propagation speeds along the impact path. The impact path tracing module 234 is further operable to incorporate/consume chaos testing results to measure failure mode centrality and resilience and refine the risk assessment and stability measures of impacted components.

In some embodiments, the impact path tracing module 234 is operable to identify one or more impact sets (i.e., a set of resource nodes that are impacted by the change) and identify the shortest chain/path and the longest chain/path of the identified impact sets. The chain/path used herein refers to a set of connected resource nodes impacted by the change. For example, the impact path tracing module 234 may be operable to process the change-dependency correlation data generated by the change-dependency correlation module 232 to trace the potential paths of impact through the dependency graph, starting from the changed components. The impact path tracing module 234 may be operable to determine the depth and breadth of potential impact for each change, by first identifying the SCC in the dependency graph. Each SCC is labeled based on its association with the changed components, such that an SCC is identified as a “changed SCC” if the SCC contains one or more nodes labeled as changed. The SCCs can be collapsed into single nodes to simplify the graph structure, and the impact path tracing module 234 may perform a forward tracing operation to determine the impact paths extending outward from the SCC. Similarly, the impact path tracing module 234 may perform a backward tracing operation to analyze the paths of impact leading into the SCC.

The impact path tracing module 234 is further operable to integrate a set of centrality measures to evaluate and prioritize the nodes and SCCs within the dependency graph. A “centrality measure” used herein refers to a quantitative metric used in a dependency graph to determine the importance, influence, or role of a particular resource (e.g., a compute instance, a node, or an edge) within a network or graph. Centrality measures are used to identify which nodes are most critical to the structure, connectivity, or information flow within the graph. In some embodiments, the centrality measures include degree centrality, betweenness centrality, and closeness centrality. Degree centrality is used to identify “hot nodes” with a significant number of incoming and outgoing connections. Changes to such nodes are labeled as “risky operations” due to the potential for widespread impact. Betweenness centrality is used to identify “bridge nodes” that control data flow between disparate components in the application deployment environment. Examples of bridge nodes include load balancers, API gateways, and Kubernetes ingress controllers. Changes to these nodes are similarly labeled as risky operations due to their critical role in the data flow in the application deployment environment. Closeness centrality is used to evaluate the average proximity of a node to all other nodes in the dependency graph. Nodes with high closeness centrality are identified as highly interconnected, such that changes to these nodes would propagate rapidly across the system. Changes to such nodes are also classified as risky operations.

The centrality measures are utilized by the impact path tracing module 234 to prioritize graph components of the dependency graph for processing and to assign impact weights to the SCCs containing high-centrality nodes. The assigned impact weights are further employed to calculate the propagation speeds of impact across each trace path. For example, SCCs containing nodes with higher centrality values are assigned higher risk scores, thereby increasing the overall risk score of a change.

In some embodiments, the centrality measures can be employed to calculate impact propagation speeds. For example, nodes with high degree centrality are associated with faster propagation due to their extensive connectivity. Similarly, nodes with high betweenness centrality and nodes with high closeness centrality are identified as critical components where changes are likely to propagate more rapidly. In some embodiments, changes within an SCC are determined to have a fast propagation speed due to the interconnections among the nodes thereof. In some embodiments, low-resilience edges can contribute to higher propagation speeds, while high-resilience edges have a slow propagation speed.

In some embodiments, the impact path tracing module 234 may employ weighted path analysis to calculate propagation speeds using a combination of the impact path length and the impact weight assigned to each resource. For example, shorter impact paths with higher impact weights may be associated with faster propagation speeds, while longer impact paths with lower weights may be associated with slow propagation speeds.

In some embodiments, the impact path tracing module 234 is operable to incorporate results from chaos testing (e.g., chaos testing results), which are available via an internal or external database, to refine the impact assessment such as centrality measures and impact weights. Chaos testing simulates failure scenarios in the application deployment environment, and the chaos testing results are used to define an additional centrality measure denoted as failure mode centrality. Failure mode centrality is used to quantify the impact of a node's failure on the overall dependency graph. For example, if the failure of a specific node results in the dependency graph being partitioned into two disjoint subgraphs, the node is assigned a high failure mode centrality value.

In some embodiments, the impact path tracing module 234 is operable to calculate/determine a measure of resilience (i.e., resilience measure), which is inversely proportional to the recovery time of a node from failure. Nodes and SCCs exhibiting high resilience measures reduce the overall risk score of the associated change. The chaos testing results can be utilized to assign impact weights to the nodes or edges in the dependency graph. High-resilience nodes or edges, which demonstrate stability and performance under testing conditions, are assigned lower impact weights, whereas low-resilience nodes or edges are assigned higher impact weights. The stability measure of an SCC is computed as a function of the weights and the resilience of the constituent nodes or edges thereof.

The impact assessment may be output, for example, by the formatted output module 242, in a structured format for integration with other components of the change analysis system 158, the deployment management system 104, or for direct consumption by stakeholders.

The dependency type classification module 236 is operable to categorize the dependencies related to the change into direct, indirect, and circular dependencies. In some embodiments, the dependency type classification module 236 is further operable to classify dependencies based on their interaction types, such as service-to-service, pod-to-pod, or inter-namespace dependencies, and label nodes and edges in the impact trace accordingly. The classifications may be used to assign weights to nodes or edges in the dependency graph and indicate the strength of dependencies in the context of the specific change.

In some embodiments, the dependency type classification module 236 is operable to perform dependency categorization by classifying dependencies into three primary types: direct dependencies, indirect dependencies, and circular dependencies. The direct dependencies involve immediate impacts on resource components directly connected to the changed resources (e.g., node or edge. The indirect dependencies are second-order or higher-order impacts propagating through intermediary nodes or edges. The circular dependencies are determined when nodes participate in cyclic paths within the dependency graph and indicate potential for recursive failures or feedback loops.

In some embodiments, the dependency type classification module 236 is operable to perform interaction-based dependency classification, where dependencies are classified by the nature of the relationships between components. Examples of interaction types may include service-to-service dependencies (e.g., between microservices), pod-to-pod dependencies (e.g., in containerized environments such as Kubernetes), cross-account resource access (e.g., shared resources across cloud accounts), runtime versus start-time dependencies (e.g., real-time interactions versus initialization requirements), inter-namespace dependencies (e.g., between resources in different namespaces), among others. The dependency type classification module 236 may label nodes and edges in the dependency graph with metadata that indicates the classifications and provide a representation of the dependency structure.

The classification results generated by the dependency type classification module 236 can be utilized to assign impact weights to resources in the dependency graph and indicate the strength or criticality of each dependency when a specific change is analyzed. Direct dependencies are generally assigned higher weights due to their immediate impact, while indirect dependencies are given medium weights to indicate their cascading effects. Circular dependencies indicating inherent risk of compounding failures may be assigned the highest weights. Additionally, interaction types (e.g., runtime dependencies) and historical data on past changes may be considered in weight assignments to indicate the specific risks or stability of certain connections. The classified and weighted dependency graph may be stored in a dependency graph storage or database in connection with the change analysis system 158.

In some embodiments, the dependency type classification module 236 is operable to adjust, refine, or update the impact weight assigned to each impacted resource by the impact path tracing module 234. The refinement/adjustment process takes into account the dependency types between resources within the dependency graph and can improve accuracy of the impact assessment. The dependency type classification module 236 can generate a weighted dependency graph and dependency classification data that includes the updated impact weights. The refinement process may begin with the identification and classification of dependencies associated with the impacted resources. Each dependency type is analyzed for its criticality and strength, with stronger or more critical dependencies contributing to higher impact weights. For example, a direct dependency between two nodes is likely to result in a more immediate and significant impact and may therefore be assigned a higher impact weight compared to an indirect dependency that involves multiple intermediary nodes. Similarly, a short impact path involving high-weighted circular or runtime dependencies may exhibit a faster impact propagation speed, while a longer path with low-weighted indirect dependencies may propagate the impact relatively slowly.

The change impact summarization module 238 is operable to aggregate the results from the change-dependency correlation module 232, the impact path tracing module 234, and the dependency type classification module 236 to generate a summary of the change impact. The change impact summarization module 238 is operable to quantify metrics such as the number of impacted resources, the depth of the impact within the dependency graph, and the distribution of the impact across different layers. The change impact summarization module 238 is further operable to generate visualizations, such as colored tree diagrams, to represent the spread of impact. The change impact summaries generated by the change impact summarization module 238 may be output and presented to the stakeholders to facilitate decision-making.

The risk estimator 240 is operable to assess the risk associated with identified changes and generate a quantitative or semi-quantitative risk estimate. In some embodiments, the risk estimator 240 may compare resources such as nodes or edges identified as risky against historical impact data to determine similarity and assign risk weights based on past outcomes. If no historical data is available, the risk estimator 240 may assign risk weights proportional to the centrality measures of the nodes or edges. The resulting risk weights may be incorporated into the overall risk score for the change.

In some embodiments, the risk estimator 240 is configured to utilize historical impact data stored in a database to assess the risk associated with nodes or edges identified as risky. For example, upon receiving the results from the dependency analyzer 208, the risk estimator 240 can match the identified risky nodes against historical records of similar changes. The matching process may involve comparing attributes such as node type, dependency type, interaction type, and past performance metrics. For nodes or edges that exhibit high similarity to historical nodes or edges, the risk estimator 240 can assign risk weights based on the outcomes of the corresponding historical changes. For example, if a similar node in the historical data caused significant disruptions during a prior change, the risk estimator 240 assigns a relatively high risk weight to the identified node.

In some embodiments, the risk estimator 240 is operable to assess risk based on centrality measures associated with the nodes in the dependency graph, especially when historical impact data is unavailable or insufficient. The risk estimator 240 can process these centrality measures and assign risk weights proportional to the values of the centrality measures. For example, nodes with high degree, betweenness, or closeness centrality are assigned higher node risk weights.

In some embodiments, the risk estimator 240 is operable to incorporate chaos testing results to refine risk weights. For example, edges in the dependency graph are assigned weights based on their resilience during chaos testing. High-resilience edges (e.g., those that maintained stability under testing) are assigned lower risk weights, while low-resilience edges are assigned higher weights. As another example, nodes within SCCs are evaluated based on their stability during chaos testing. The risk estimator 240 can calculate stability measures for SCCs as a function of the resilience of their constituent nodes and edges. Nodes and SCCs with lower stability measures are assigned higher risk weights.

In some embodiments, the risk estimator 240 is operable to aggregate the risk weights assigned to individual resources to generate a risk estimate for the proposed change. The risk estimate may be a quantitative or semi-quantitative measure of the risk assessment. As an example, the risk estimate may be determined by evaluating factors such as the number and criticality of high-risk nodes and edges, the propagation speed and breadth of impact paths, as determined by centrality measures and dependency classifications, the stability and resilience of the affected SCCs, among others. The risk estimate is presented as an output for use by other modules within the change analysis system 158, such as the blast radius identifier 210, the risk scoring engine 212, and the visualization and reporting engine 224.

In some embodiments, the risk estimator 240 is operable to dynamically update risk assessments when new data becomes available. For example, if chaos testing results are updated, the risk estimator 240 can recalculate risk weights and adjust the overall risk score accordingly.

The formatted output module 242 is operable to output and present the results of the dependency analysis, including summaries, risk assessments, and visualizations in a clear and structured format. In some embodiments, the formatted output module 242 can generate outputs for integration with other system components or for direct consumption by stakeholders.

The blast radius identifier 210 is operable to determine the extent of the impact caused by a change, both within a single architectural layer and across multiple architectural layers according to the dependency graph. The blast radius identifier 210 can identify the vertical boundaries (e.g., across multiple layers of a dependency graph) and horizontal boundaries (e.g., within a single layer of a dependency graph) of the change impact, identify critical transition points, and calculate a blast radius score (e.g., change scope data) to quantify the overall extent of the impact.

For example, the blast radius identifier 210 can identify transitions across architectural layers, such as changes propagating from the application layer to the platform layer, or from the application layer through the platform layer to the infrastructure layer, etc. The blast radius identifier 210 can also determine the propagation of changes within a single layer and identify the breadth of impact on components or services at the same level of the architecture. For instance, within the application layer, the blast radius identifier 210 may trace changes affecting multiple microservices and determine the extent of the impact within the application layer.

The blast radius identifier 210 is further operable to identify areas where the change impact crosses critical boundaries in the architecture. The boundaries are referred to as points where changes transition between components with differing characteristics. For example, state transitions refer to the change impact moving from stateless to stateful services. Resource transitions refer to the change impact moving from processing components to databases or storage components. Stability transitions refer to change impact moving from high-stability resources (e.g., mature, well-tested components) to low-stability resources (e.g., experimental or newly deployed components).

The blast radius identifier 210 is operable to calculate a blast radius score to quantify the scope and criticality of the change impact. In some embodiments, the blast radius score is a weighted sum of the number and type of impacted resources, with weights inversely related to the relative distance of resource (e.g., indicated in the dependency graph) from the origin of the changed resource. As an example, the blast radius score calculation may involve at least one of: (1) assigning weights to resources, (2) aggregating impact metrics, and (3) incorporating risk factors. In assigning weights to resources, resources directly impacted by the change may be assigned higher weights; resources indirectly impacted (e.g., downstream dependencies) may be assigned lower weights based on their distance from the origin of the change in the dependency graph, and some critical resources, such as those identified through centrality measures (e.g., high-degree nodes, bridge nodes, or nodes with high failure mode centrality), may be assigned additional weights. In aggregating the impact metrics, the number of impacted resources, the depth of the impact (number of dependency levels affected), and the distribution of the impact across architectural layers and infrastructural components may be taken into account. For example, changes that affect multiple high-stability components across several layers may result in a higher blast radius score. In incorporating the risk factors, the transitions across critical boundaries and the resilience of impacted components may be taken into the blast radius score.

For example, impacts on low-resilience components or transitions involving stateful services may be assigned with additional weights in the blast radius score. The blast radius identifier 210 may output the blast radius score for use by other components of the change analysis system 158.

The test case selector and executor 206 is generally responsible for selecting test cases for testing the application, triggering execution of the test cases, analyzing the test results of the test cases executed, and bridging the gap between impact analysis and testing. In some embodiments, the test case selector and executor 206 is operable to establish and maintain a mapping between architectural layers/resources and the test cases. The mapping can be dynamically updated to reflect the evolving architecture and test coverage data. Test cases are categorized based on their coverage percentage and testing type, such as functional, performance, or stability tests, for efficient classification and retrieval. For example, a functional test case may be associated with specific APIs, while performance test cases may be associated with services or infrastructure components.

The test case selector and executor 206 is operable to query the test case mapping to select the most relevant test cases for the impacted resource components. For example, if a change in the database schema impacts downstream query operations, the test case selector and executor 206 can select test cases that specifically validate the downstream query operations.

The test case selector and executor 206 is also operable to incorporate output of the risk estimator 240 to prioritize test cases based on the assessed risk of the impacted resources. Higher-risk changes, such as the changes involving critical or highly interconnected resources, trigger the execution of more extensive or comprehensive test suites, while lower-risk changes may require only lightweight validation through a subset of tests, such as smoke tests. For example, if the risk estimator 240 identifies a high-risk node within the dependency graph, the test case selector and executor 206 can assign a higher priority to the identified node for testing.

The test case selector and executor 206 is also operable to orchestrate the execution of selected test cases through existing test execution environments (e.g., pre-production or experimental environments). In some embodiments, the test case selector and executor 206 can query a test results database within the change analysis system 158 to verify whether the relevant test cases for the identified deployment or update have already been executed and passed. If any required tests remain unexecuted or have failed, the test case selector and executor 206 can initiate execution through integrated test frameworks. The orchestration process assumes the availability of automation for parallelizing test case execution and aggregating results into a unified output. For example, the test case selector and executor 206 may execute functional and performance tests in parallel to streamline the testing process.

The test case selector and executor 206 is operable to analyze the results from execution of the test cases and correlate test failures with the original change and the impacted resource components. The test case selector and executor 206 can evaluate pass rates for each test suite against predefined thresholds established for different test types. For example, if the pass rate for a performance test suite falls below a predetermined threshold indicating acceptable, the test case selector and executor 206 can generate a test result summary and store the test result summary in the historical impact database 218. In some embodiments, the test result summary may be used by the risk scoring engine 212 to update/adjust the testing-related risk scores for the impacted resource components (e.g., adjustment of the initial risk score may be proportional to the percentage of failed tests).

The test case selector and executor 206 is also operable to track test coverage for each change and integrate with other quality assurance (QA) tools to monitor coverage over time. For example, if test coverage for a given change falls below a predefined threshold, or if a critical area of the architecture or an architectural layer lacks adequate test coverage, the test case selector and executor 206 can trigger or generate an alert to update or expand the test cases.

In some embodiments, the test case selector and executor 206 is operable to incorporate adaptive learning capabilities to improve the accuracy and efficiency of test selection and prioritization. For example, the test case selector and executor 206 can employ a machine learning model. The machine learning model may be developed and trained with historical data to identify patterns in test effectiveness for different types of changes. If a specific test is historically effective at identifying defects, the test case selector and executor 206 can assign higher priority to the test when similar changes are proposed. In some embodiments, the test case selector and executor 206 can employ clustering and classification techniques to group similar changes and predict the most relevant test cases based on the historical data.

The risk scoring engine 212 is operable to calculate a risk score based on multiple inputs, including outputs from one or more of the risk estimator 240, the blast radius identifier 210, and test case selector and executor 206. The risk score quantifies the potential impact and criticality of the change. In some embodiments, the risk scoring engine 212 is operable to calculate a numeric risk score by the risk weights or the risk estimate determined by the risk estimator 240. In some embodiments, the risk scoring engine 212 is operable to calculate a numeric risk score based on the blast radius score generated by the blast radius identifier 210. In some embodiments, the risk scoring engine 212 is operable to calculate a numeric risk score based on the test result summary generated by the test case selector and executor 206. In some embodiments, the risk scoring engine 212 can combine the risk weights data and the blast radius score using a weighted aggregation method to generate a numeric risk score that indicates both the severity (e.g., from the risk estimator 240) and the scope (e.g., from the blast radius identifier 210) of the proposed change. In some embodiments, the risk scoring engine 212 can adjust/update the initial risk score to generate a final risk score, based on other data such as the pass rate of test cases from the test result summary. The risk score is presented to stakeholders to guide decision-making, such as change approval, mitigation strategies, or rollback planning.

The change cost estimator 214 is operable to match the impacted resources and attributes to predefined cost data and generate an estimated cost impact. In some embodiments, the change cost estimator 214 can receive the identification of the changed resources and impacted resources, retrieve entries in the resource cost catalogue from a predefined database containing cost information, and match the identified resources to the entries. The cost information may include static costs (e.g., subscription or licensing fees) and variable costs based on usage (e.g., compute hours, data transfer rates, or storage volume).

In some embodiments, the change cost estimator 214 can initially assume an average usage pattern based on historical data or industry benchmarks, for resources having variable costs. The initial assumption allows the change cost estimator 214 to calculate a baseline cost estimate even in the absence of specific usage data for the proposed change.

The change cost estimator 214 can store the estimated cost data in the historical impact database 218 for future reference and analysis. Over time, as actual resource usage data becomes available, the change cost estimator 214 can determine the difference between the predicted usage and the actual usage. The difference, referred to as estimation error, is continuously recorded and used to improve the accuracy of future estimates. In some embodiments, the change cost estimator 214 can apply a correction factor to its “average” usage assumption based on the observed errors to adapt to system-specific usage patterns over time.

The performance impact analyzer 216 is operable to analyze performance degradation or improvements resulting from changes based on MELT data and/or dependency mapping data, and to identify performance bottlenecks and correlate resource utilization across architectural layers. In some embodiments, the performance impact analyzer 216 ingests MELT data from observability and the deployment monitoring system 162 spanning all architectural layers, including application, platform, and infrastructure layers according to the dependency graph. The performance impact analyzer 216 is further operable to process the output of the dependency analyzer 208, which identifies the changes and their associated dependencies in the dependency graph. In some embodiments, the performance impact analyzer 216 can include multiple sub-components respectively responsible for different functions such as data collection, pre-processing, training, validation, etc.

The performance impact analyzer 216 can identify performance bottlenecks arising from the changes. For example, the performance impact analyzer 216 can detect that a spike in CPU utilization at the infrastructure layer corresponds to an increase in application response times and identify the infrastructure resource as a bottleneck. In another example, the performance impact analyzer 216 can detect performance degradation in database query execution times following a schema change.

In some embodiments, the performance impact analyzer 216 can employ machine learning models such as Long Short-Term Memory (LSTM) networks and Prophet to enhance its ability to detect and predict performance issues. LSTM models may analyze temporal dependencies in time-series data and allow for detection of subtle performance degradations. Prophet may provide predictive capabilities to identify performance trends and anomalies associated with changes.

In some embodiments, the performance impact analyzer 216 can perform resource utilization mapping, for example, correlating resource consumption data at lower architectural layers with performance metrics at upper architectural layers. The performance impact analyzer 216 can provide a holistic view of how resource utilization impacts overall performance through the vertical mapping. For example, increased disk I/O activity at the infrastructure layer may be linked to latency spikes in the application layer. The performance impact analyzer 216 can employ machine learning techniques such as principal component analysis (PCA) to reduce the dimensionality of resource utilization data and identify the most significant factors contributing to performance changes. LSTM models can also be employed to model the temporal relationships between resource utilization and performance metrics.

The visualization and reporting engine 224 is operable to generate visualizations and reports based on outcomes from various modular components of the change analysis system 158, including the dependency analyzer 208, risk scoring engine 212, blast radius identifier 210, performance impact analyzer 216, and test case selector and executor 206. The visualization and reporting engine 224 can provide interactive dependency graph visualizations that highlight impacted resources, critical nodes/edges, and impact paths of propagation, using attributes such as centrality measures, impact weights, risk weights, and propagation speeds to emphasize areas of concern. The visualization and reporting engine 224 can generate risk heatmaps and blast radius diagrams to illustrate the scope and severity of changes, along with dashboards displaying test results, coverage analysis results, and performance changes.

The deployment gatekeeper 250 of the change analysis system 158 is a modular component operable to determine whether a proposed deployment can be approved or blocked based on aggregated data from various sources, including risk assessment summary, test result summary, blast radius score, dependency impact summaries, cost change estimate, and performance change. In some embodiments, the deployment gatekeeper 250 compares the risk score generated by the risk scoring engine 212 against a predefined threshold to determine whether the deployment poses an acceptable level of risk. For example, deployments with a risk score exceeding a predetermined threshold may be flagged for additional review or rejection unless mitigating measures are implemented.

In some embodiments, the deployment gatekeeper 250 can decide on releasing or blocking the deployment based on the test results and coverage data generated by the test case selector and executor 206. The deployment gatekeeper 250 can verify whether all relevant test cases have been executed and whether test pass rates meet or exceed predefined thresholds. Deployments with insufficient test coverage or below-threshold pass rates are blocked until these deficiencies are resolved.

In some embodiments, the deployment gatekeeper 250 can decide on blocking or releasing the deployment based on whether the blast radius score generated by the blast radius identifier 210 exceeds acceptable thresholds, particularly when changes affect critical or highly interconnected components. For example, changes with a large blast radius that crosses critical boundaries, such as transitions between stateful and stateless services or between high-resilience and low-resilience systems, may trigger a deployment block.

In some embodiments, the deployment gatekeeper 250 can decide on blocking or releasing the deployment based on the impact summary generated by the dependency analyzer 208. The impact summary identifies the direct and indirect dependencies affected by the change and determines whether all impacted areas identified in the dependency summary have been accounted for in the risk assessment and test coverage. If any dependencies remain untested or unaccounted for, the deployment gatekeeper 250 may block the deployment until the gaps are resolved.

In some embodiments, the deployment gatekeeper 250 can use the impact predictions generated by the performance impact analyzer 216 to determine whether the deployment is likely to cause performance degradation, such as increased response times or higher resource utilization. The deployment gatekeeper 250 can flag or block the deployments predicted to result in unacceptable performance impacts until mitigating actions are implemented.

The deployment gatekeeper 250 is operable to apply a set of predefined rules and thresholds to these inputs to determine deployment readiness. The rules are predefined based on the operational requirements and can be updated periodically. The deployment gatekeeper 250 can operate to make a decision on blocking or releasing the deployments based on a collection of the criteria. For example, the deployment gatekeeper 250 can assign weights and priorities to each input (e.g., the risk score generated by the risk scoring engine 212, the blast radius score generated by the blast radius identifier 210, the coverage data generated by the test case selector and executor 206, etc.). For example, a low-risk deployment with a limited blast radius may proceed even if some non-critical test cases fail, while a high-risk deployment with a wide blast radius may be blocked despite passing all tests.

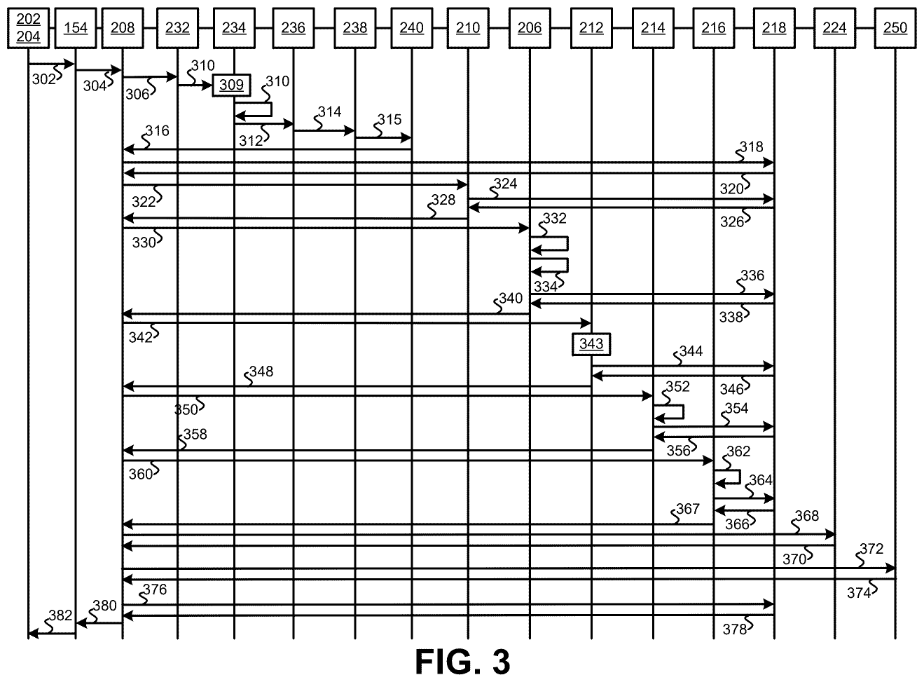

FIG. 3 is a message flow diagram illustrating communications among components of the change analysis system 158 shown in FIGS. 2A and 2B as well as communications between the components of the change analysis system 158 and external sources. At 302, the API 204 in conjunction with the CI/CD pipeline integration module 202 operates to transmit a change analysis request to the automated dependency management system 154. In some implementations, when the CI/CD pipeline detects a forthcoming deployment event, whether for a new application or an update to an existing application intended for deployment into a production environment, the pipeline integration module 202 generates a request including deployment metadata, such as application identifiers and target environment details, and the API 204 transmits the request to the automated dependency management system 154.

At 304, the dependency management system 154 is operable to generate a dependency graph corresponding to a new application or an update to an existing application. The dependency graph indicates one or more resources associated with the application and the dependency relationships among those resources. The operation may include identifying any changes in the resources themselves or in the dependency relationships between the resources. Once generated, the dependency management system 154 provides access to the dependency graph by either transmitting to the dependency analyzer 208 of the change analysis system 158 or allowing the change analysis system 158 to retrieve the dependency graph. Additional details regarding the generation of the dependency graph are described in U.S. Patent Application with Attorney Docket No. P2024-05-02 (1446931), filed concurrently, titled “AUTOMATED DEPENDENCY MANAGEMENT FOR APPLICATION DEPLOYMENT,” the disclosure of which is incorporated herein by reference in its entirety

At 306, the dependency analyzer 208 receives the dependency graph associated with the application from the dependency management system 154. Upon receipt, the dependency analyzer 208 triggers the change-dependency correlation module 232 to perform a correlation analysis between the identified changes and the resources and relationships represented in the dependency graph.

At 308, the change-dependency correlation module 232 is operable to map the change onto the dependency graph and identify one or more resources (e.g., resources components) and services that are directly or indirectly connected to the changed resource. The change-dependency correlation module 232 subsequently generates change-dependency correlation data, which includes the relationships between the proposed change and the impacted resources or services. The change-dependency correlation module 232 operates to provide access to the change-dependency correlation data to the impact path tracing module 234 and trigger the impact path tracing module 234 to operate.

At 309, the impact path tracing module 234 operates to perform at least one of the following: identifying one or more impacted resources (e.g., resources impacted by the change), identifying one or more impact paths caused by the change across the dependency graph, determining the shortest path and the longest path of impacted resources, identifying one or more strongly connected component (SCC) within the dependency graph, determining a centrality measure for each one of the impacted resource, calculating an impact propagation speed for the impact path, and assigning an impact weight to each impacted resource. The impact path tracing module 234 is operable to generate an impact assessment summary including impact assessment data indicating the identification of impacted resources, the impact paths, the centrality measures, the impact propagation speeds, and the stability measures for impacted SCCs, and the impact weights assigned to the impacted resources.

Optionally, at 310, the impact path tracing module 234 may operate to retrieve chaos testing results from a chaos testing database in connection with the change analysis system 158 to refine the impact assessment (e.g., the centrality measures and impact weights). The impact path tracing module 234 may determine a failure mode centrality for each impacted resource, calculate/determine a resilience/stability measure for each impacted resource, and assign/refine the impact weight based on the failure mode centrality and/or the resilience/stability measure for each impacted resource.

At 312, the impact path tracing module 234 provides access to the impact assessment data to the dependency type classification module 236 and triggers the dependency type classification module 236 to operate.

At 314, the dependency type classification module 236 operates to classify/determine the dependency types and refine/update the impact weight assigned to each impact resource by the impact path tracing module 234. The dependency type classification module 236 generates dependency classification data that includes dependency types associated with the impacted resources, the updated impact weights assigned to each impacted resource, and the weighted dependency graph. The dependency type classification module 236 provides access to the dependency classification data to the change impact summarization module 238 and triggers the change impact summarization module 238 to operate.

At 315, the change impact summarization module 238 operates to aggregate the results from the change-dependency correlation module 232 and impact path tracing module 234 to generate a summary of the change impact, provide access to the change impact summary to the risk estimator 240, and triggers the risk estimator 240 to operate.

At 316, the risk estimator 240 operates to assess the risk associated with identified changes and generate a quantitative or semi-quantitative risk estimate. The risk estimator 240 can assess the risk and assign a risk weight to each impacted resource based on one or more factors including but not limited to: a comparison of impacted resources identified as risky against historical impact data, the centrality measure associated with the impacted resources in the dependency graph, chaos testing results such as resilience/stability measure, etc. The risk estimator 240 operates to aggregate the risk weights assigned to individual resources, generate a risk assessment (e.g., a risk estimate) for the identified change, and return the risk assessment to the dependency analyzer 208.

At 318, the dependency analyzer 208 operates to store all data generated by the modular components of the dependency analyzer 208 in the historical impact database 218. The data includes the change-dependency correlation data, the weighted dependency graph, centrality measures, impact weights, risk weights assigned to each impacted resource, dependency classification data, risk estimate, etc. The data is denoted as the initial impact data. At 320, the historical impact database 218 confirms the receipt of the initial impact data.

At 322, the dependency analyzer 208 triggers the blast radius identifier 210 to determine a blast radius for the change. At 324, the blast radius identifier 210 operates to determine architectural layers of the dependent graph associated with the application, determine the architectural layers impacted by the change, determine/calculate a blast radius score for the change. Calculation of the blast radius score can be performed based on the architectural layer, the impact weight assigned to the impacted resources, and the risk weights assigned to the resources in each architectural layer. The blast radius identifier 210 may store the blast radius data in the historical impact database 218 and update the initial impact data with the blast radius data. At 326, the historical impact database 218 confirms the receipt of the updated impact data with the blast radius data and returns the confirmation to the blast radius identifier 210. At 328, the blast radius identifier 210 returns the blast radius data to the dependency analyzer 208.

At 330, the dependency analyzer 208 triggers the test case selector and executor 206 to select test cases for testing the application in a pre-production environment. At 332, the test case selector and executor 206 operates to retrieve test cases from a test database (e.g., database 130 of FIG. 1) in connection with the change analysis system 158, identify/determine test cases for testing the application, select test cases for execution based on the relevancy to the change. The test database returns the selected test cases to the test case selector and executor 206. At 334, the test case selector and executor 206 operates to trigger execution of test cases and obtain test results. For example, the test case selector and executor 206 sends the selected test cases to the test pipeline integrated into the application testing 118. The test pipeline operates to execute the selected cases to test the application and return test results to the test case selector and executor 206. The test case selector and executor 206 may further operate to verify that the selected test cases have been executed. At 336, the test case selector and executor 206 stores the test results in the historical impact database 218. At 338, historical impact database 218 returns a confirmation of receipt of the test results to the test case selector and executor 206. At 340, the test case selector and executor 206 generate a test result summary and return the test result summary to the dependency analyzer 208.

At 342, the dependency analyzer 208 triggers the risk scoring engine 212 to calculate a risk score. At 343, the risk scoring engine 212 operates to calculate a risk score based on multiple inputs, including outputs from at least one of the risk estimator 240, the blast radius identifier 210, and the test case selector and executor 206. The risk scoring engine 212 may retrieve the initial impact data from the historical impact database 218, calculate an initial risk score based on the initial impact data, and refine/update the initial score based on updated impact data and risk assessment data such as the blast radius score, chaos testing results, test results from execution of selected test cases, and other data generated by the modular components of the change analysis system 158. At 344, the risk scoring engine 212 operates to store the risk score data in the historical impact database 218 and update the impact and risk assessment data related to the change. At 346, the historical impact database 218 returns a confirmation that the impact and risk assessment data has been updated to the risk scoring engine 212. At 348, the risk scoring engine 212 returns the risk score to the dependency analyzer 208.

At 350, the dependency analyzer 208 triggers the change cost estimator 214 to calculate a change cost estimate for the identified change. At 352, the change cost estimator 214 retrieves resource cost entries from a predetermined resource cost catalogue stored in a database connected to the change analysis system 158, calculate a baseline cost (e.g., reference cost) of the resources without the change, calculate a predicted cost based on the changed resources, and determine a change cost estimate based on the difference between the baseline cost and the predicted cost. The change cost estimator 214 may further compare the change cost estimate against a predetermined threshold and determine whether the change cost is acceptable. At 354, the change cost estimator 214 stores the change cost data in the historical impact database 218. At 356, the historical impact database 218 returns a confirmation of receipt to the change cost estimator 214. At 358, the change cost estimator 214 returns the change cost estimate to the dependency analyzer.

At 360, the dependency analyzer 208 triggers the performance impact analyzer 216 to analyze performance results from changes. At 362, the performance impact analyzer 216 retrieves monitoring data from an observability and monitoring database connected to the change analysis system 158. The monitoring data include MELT data, which is processed by the performance impact analyzer 216 to identify performance bottlenecks, determine a change in performance and decide whether the change in performance is acceptable against a predetermined threshold, correlate resource utilization across architectural layers according to the dependency graph. At 364, the performance impact analyzer 216 generates performance analysis results and stores the performance analysis results in the historical impact database 218. At 366, the historical impact database 218 returns a confirmation to the performance impact analyzer 216. At 367, the performance impact analyzer 216 returns the performance analysis results to the dependency analyzer 208.

At 368, the dependency analyzer 208 triggers the visualization and reporting engine 224 to generate a change analysis summary. At 370, the visualization and reporting engine 224 returns the change analysis summary to the dependency analyzer 208.

At 372, the dependency analyzer 208 sends a request for decision to the deployment gatekeeper 250. At 374, the deployment gatekeeper 250 determines whether deployment of the new application or the update of an application can be approved or blocked based on the change analysis summary and data included therein. For example, the deployment gatekeeper 250 can make a determination based on aggregated impact data from various sources, including the risk scores, test result summaries, blast radius data, dependency impact summaries, change cost estimates, performance impact predictions, among others. The deployment gatekeeper 250 returns the decision to the dependency analyzer 208.

At 376, the dependency analyzer 208 operates to store the final consolidated impact data (e.g., initial impact data, updated impact data, change analysis summary, and decision) in the historical impact database 218. At 378, the historical impact database 218 returns a confirmation of receipt to the dependency analyzer 208.

At 380, the dependency analyzer 208 returns the change analysis summary to the automated dependency management system 154. At 382, the dependency management system 154 returns the change analysis summary to the API 204 and the CI/CD pipeline integration module 202.

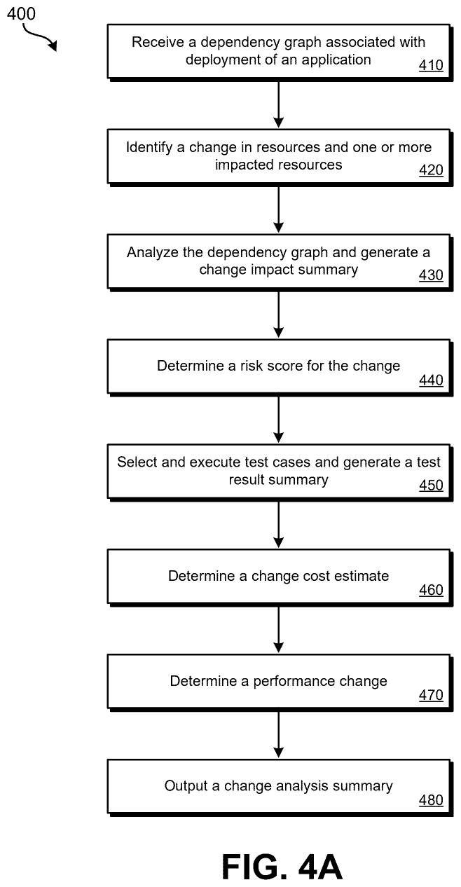

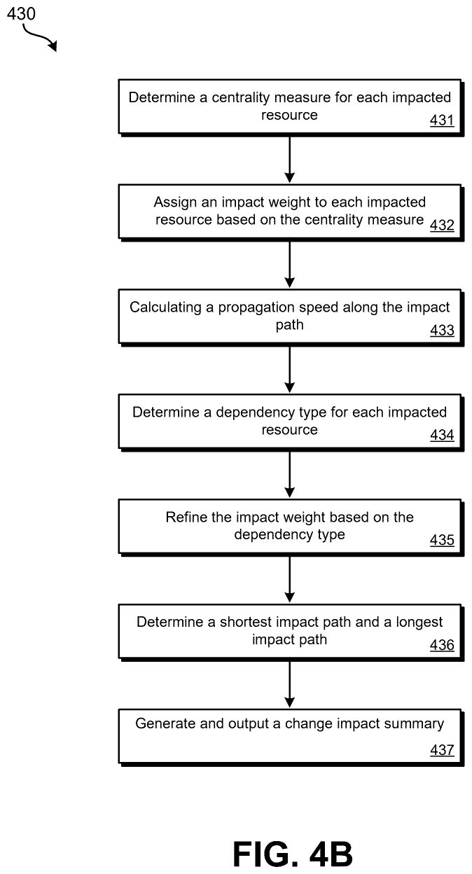

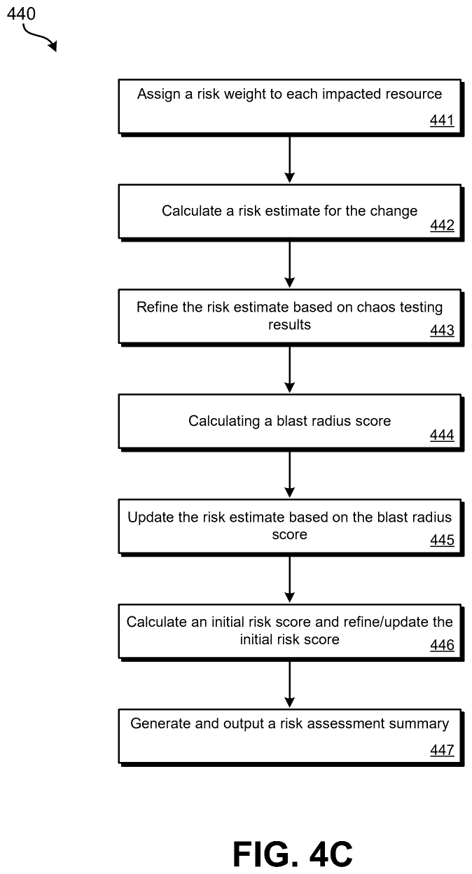

FIG. 4 illustrates an example method 400 for change analysis performed by the change analysis system 158 of FIGS. 2A and 2B according to the message flow diagram of FIG. 3. Method 400 includes process blocks 410-480. Fewer or additional process blocks may be included, and process blocks of method 400 may be combined with process blocks of other methods or processes provided in the present application in a suitable manner. FIGS. 4B and 4C respectively illustrate examples of process blocks 430 and 440 of method 400 illustrated in FIG. 4A.

At 410, a dependency graph associated with an application or an update to the application, intended for deployment in a target environment, is received by the change analysis system. The dependency graph represents resources within the target environment and specifies the dependency relationships among these resources. In some embodiments, the dependency graph further delineates the architectural layers within the target environment and maps resources to their corresponding layers. In some implementations, a change in resources associated with deployment of the application or update is mapped, by the change-dependency correlation module of the dependency analyzer, onto the dependency graph. In some implementations, the change is mapped based on a comparison between a predetermined reference state and an updated state of the resources associated with the application deployment.

At 420, the dependency graph is analyzed by the dependency analyzer to identify one or more changed resources introduced by the change and one or more impacted changes (i.e., resources impacted by the changed resources).

At 430, the dependency graph is further analyzed by modular components of the dependency analyzer, and a change impact summary is generated by modular components of the dependency analyzer. In some implementations, process block 430 further includes additional process blocks, as illustrated in FIG. 4B.

At 431, a centrality measure is determined, by the impact path tracing module, for each impacted resource according to the dependency graph. The centrality measure may be selected from at least one of degree centrality, betweenness centrality, and closeness centrality. At 432, an impact weight is assigned, by the impact path tracing module, to each impacted resource based on the centrality measure. At 433, an impact propagation speed along the impact path is calculated by the impact path tracing module. At 434, a dependency type is determined, by the dependency type classification module, for each impacted resource. At 435, the impact weight is adjusted or refined, by the dependency type classification module, based on the dependency type. At 436, the shortest impact path and the longest impact path of the one or more impacted paths are determined, by the impact path tracing module. At 437, a change impact summary including the impact analysis results is generated by the change impact summarization module, stored in a database connected to the change analysis system, and output by the formatted output module.

Referring back to FIG. 4A, at 440, a risk score is determined for the change, by the risk scoring engine of the change analysis system. In some implementations, process block 440 further includes additional process blocks, as illustrated in FIG. 4C. At 441, a risk weight is assigned, by the risk estimator, to each impacted resource, based on the change impact summary (e.g., the centrality measure of the impacted resource). At 442. A risk estimate is calculated for change by the risk estimator, based on the risk weight assigned to each one of the impacted resources. At 443, chaos testing results of the application are received in the risk estimator, a resilience measure for each impacted resource is determined, by the risk estimator, based on the chaos testing results, the risk weight for each impacted resource is refined/updated, by the risk estimator, based on the resilience measure, and the risk estimate for the change is updated, by the risk estimator, based on the refined/updated risk weight.

At 444, a blast radius score is calculated, by the blast radius identifier. In some implementations, one or more transitions in each one of the impacted paths according to the dependency graph are identified, a transition type is determined for each transition. The transition type may be selected from a horizontal transition and a vertical transition. The horizontal transition indicates that the transition is within an architectural layer of the dependency graph, and the vertical transition indicates that the transition crosses two adjacent architectural layers of the dependency graph. The blast radius score of the blast area is calculated based at least in part on a distance between each one of the impacted resources from the changed resource, the transition type, and a total number of the transitions. At 445, the risk estimate is updated, by the risk estimator, based on the blast radius score. At 446, an initial risk score is calculated, by the risk scoring engine, based on the risk estimator. In some implementations, the initial risk score may be adjusted or updated, by the risk scoring engine, based on the test results from execution of test cases and/or the change cost estimate. At 447, a risk assessment summary is generated and output, by the visualization and reporting module.

Referring back to FIG. 4A, at 450, test cases are selected by the test case selector and executor, and a test result summary is generated by the test case selector and executor. In some implementations, test cases are selected from a database connected to the computer system, based on a predetermined mapping between the impacted resources and the test cases. Execution of the selected test cases is triggered to test the application in a pre-production environment. Test results from the execution of the selected test cases are received in the test case selector and executor and analyzed to determine a pass rate of the testing. A test result summary including the pass rate along with additional metrics relevant to the test case execution process is generated. In some implementations, the test results are further used to refine the initial risk score associated with the proposed change. For example, if the pass rate meets or exceeds a predefined threshold, the initial risk score may be adjusted upward to reflect increased confidence in the deployment. Conversely, if the pass rate falls below the threshold, the initial risk score may be decreased to account for the heightened risk posed by failed or insufficient testing.

At 460, a change cost estimate is determined, by the change cost estimator. In some implementations, a predetermined cost for the resources according to the dependency graph is obtained from a preestablished resource cost catalogue, and a change cost estimate for the change is calculated based on the predetermined cost for the resources and the impacted resources. For example, the change cost estimate can be calculated by identifying the impacted resources from the dependency graph and aggregating their associated costs. For resources with variable costs based on usage, an average usage pattern derived from historical data or benchmarks is used to estimate the cost. In some implementations, the change cost estimate may be used to update the initial risk score. For example, the cost estimate is compared against predefined thresholds to adjust the risk score, with higher costs increasing the risk score and lower costs reducing the risk score.

At 470, a performance change is determined, by the performance impact analyzer. In some implementations, MELT data across various architectural layers according to the dependency graph in conjunction with the change-dependency correlation data is obtained by the performance impact analyzer. Performance changes can be identified by correlating resource utilization metrics (e.g., CPU, memory, disk I/O) with application performance metrics (e.g., response times, throughput, latency). Various machine learning models, such as LSTM networks or Prophet, may be employed by the performance impact analyzer to detect performance degradation or improvements following a change. In some implementations, the performance change may be used to refine/update the initial risk score. For example, performance degradations, such as increased latency, reduced throughput, or bottlenecks in critical resources, may result in higher risk scores, while minimal or no performance impact reduces the risk score.

At 480, a change analysis summary including all of the results generated from change analysis by the change analysis system is generated and output by the visualization and reporting module.

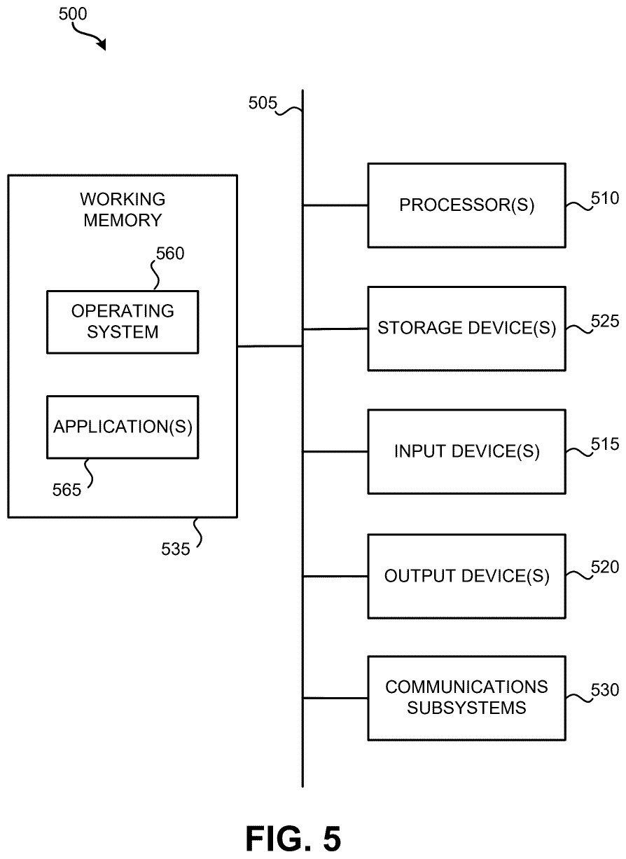

The communications system 100 or any components thereof, such as the change analysis system 158 as described above, may include a computer system that further includes computer hardware and software that form special-purpose network circuitry to implement various embodiments such as communication, generation of data, determination, identification, calculation, performing a process or other process blocks of the methods described herein. FIG. 5 is a schematic diagram illustrating an example of computer system 500. The computer system 500 is a simplified computer system that can be used to implement various embodiments described and illustrated herein. FIG. 5 provides a schematic illustration of one embodiment of a computer system 500 that can perform some or all of the steps of the methods and workflows provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner. The computer system 500 is shown including hardware elements that can be electrically coupled via a bus 505, or may otherwise be in communication, as appropriate. The hardware elements may include one or more processors 510, including without limitation one or more general-purpose processors and/or one or more special-purpose processors such as digital signal processing chips, graphics acceleration processors, and/or the like; one or more input devices 515, which can include without limitation a mouse, a keyboard, a camera, and/or the like; and one or more output devices 520, which can include without limitation a display device, a printer, and/or the like.

The computer system 500 may further include and/or be in communication with one or more non-transitory storage devices 525, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 530 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 530. In other embodiments, a portable electronic device, e.g., the first electronic device, may be incorporated into the computer system 500, e.g., an electronic device as an input device 515. In some embodiments, the computer system 500 will further include a working memory 535, which can include a RAM or ROM device, as described above.

The computer system 500 also can include software elements, shown as being currently located within the working memory 535, including an operating system 560, device drivers, executable libraries, and/or other code, such as one or more application programs 565, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 5, might be implemented as code and/or instructions executable by a computer and/or a processor within a computer; in one embodiment, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 525 described above. In some cases, the storage medium might be incorporated within a computer system, such as computer system 500. In other embodiments, the storage medium might be separate from a computer system e.g., a removable medium, such as a compact disc, and/or provided in an installation package, and the storage medium can be used to program, configure, and/or adapt a general-purpose computer with the instructions/code stored thereon. These instructions might take the form of executable code, which is executable by the computer system 500 and/or might take the form of source and/or installable code, which, upon compilation and/or installation on the computer system 500 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, some embodiments may employ a computer system such as the computer system 500 to perform methods in accordance with various embodiments of the technology. According to a set of embodiments, some or all of the operations of such methods are performed by the computer system 500 in response to processor 510 executing one or more sequences of one or more instructions, which might be incorporated into the operating system 560 and/or other code, such as an application program 565, contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. In one embodiment, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 and/or components thereof generally will receive signals, and the bus 505 then might carry the signals and/or the data, instructions, etc. carried by the signals to the working memory 535, from which the processor(s) 510 retrieves and executes the instructions. The instructions received by the working memory 535 may, in one embodiment, be stored on a non-transitory storage device 525 either before or after execution by the processor(s) 510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a test case” includes a plurality of such test cases, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

As used herein, a “resource” is an identifiable entity, component, or object within an application deployment environment that provides functionality, services, or information and can be utilized to achieve specific objectives. Resources are distributed across various architectural layers in the application deployment environment, such as infrastructure (e.g., compute instances, networks, load balancers), application (e.g., microservices, APIs), data (e.g., databases, files), and configuration (e.g., environment variables, deployment manifests). Each resource is uniquely identifiable, has attributes (e.g., configuration settings, size), maintains a state (e.g., active, idle, updated), and may have relationships with other resources (e.g., dependencies or interactions).

As used herein, a “change in resource” or a “changed resource” is a resource component that is directly modified or updated as part of the proposed deployment or change. The changes in resource can include changes to the configuration, state, functionality, dependencies, or any other aspect explicitly altered during the update or deployment process.

As used herein, an “impacted resource” is a resource that is not directly modified but is indirectly affected by the change to another resource due to dependency relationships. The impact can be a result of the propagation of the change through the dependency graph, where the behavior, performance, or functionality of the resource is influenced by the change in a directly modified resource.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered.

What is claimed is:

1. A method comprising:
receiving, in a computer system, a dependency graph associated with an application or an update to the application for deployment in a target environment, the dependency graph indicating resources within the target environment and dependency 4 relationships among the resources;
identifying, by the computer system, a change in resources caused by the application and one or more impact paths from the dependency graph, each one of the impact paths indicating one or more changed resources associated with the application and one or more impacted resources originating from the one or more changed resources across the dependency graph;
generating, by the computer system, a change impact summary, the change impact summary indicating the one or more impact paths; and
outputting, by the computer system, the change impact summary.

2. The method of claim 1, further comprising:
determining, by the computer system, a centrality measure for each one of the impacted resources, the centrality measure selected from at least one of degree centrality, betweenness centrality, and closeness centrality;
assigning, by the computer system, an impact weight to each one of the impacted resources based on the centrality measures; and
calculating, by the computer system, an impact propagation speed of the change along the impact path through the dependency graph.

3. The method of claim 2, further comprising:
determining, by the computer system, a dependency type for each one of the impacted resources based on the dependency relationship between the impacted resource and the changed resource, the dependency types selected from a direct dependency, an indirect dependency, and a circular dependency; and
refining, by the computer system, the impact weight assigned to each one of the impacted resources based on at least in part on the dependency type.

4. The method of claim 1, further comprising:
determining, by the computer system, the shortest impact path and the longest impact path of the one or more impacted paths.

5. The method of claim 2, further comprising:
assigning, by the computer system, a risk weight to each one of the impacted resources based at least on the centrality measure of the impacted resource; and
calculating, by the computer system, a risk estimate for the change based on the risk weight assigned to each one of the impacted resources.

6. The method of claim 5, further comprising:
receiving, in the computer system, chaos testing results of the application;
determining, by the computer system, a resilience measure for each one of the impacted resources based on the chaos testing results;
refining, by the computer system, the risk weight for each one of the impacted resources based on the resilience measure; and
updating, by the computer system, the risk estimate for the change based on the refined risk weight.

7. The method of claim 1, further comprising:
identifying, by the computer system, one or more transitions in each one of the impacted paths,
determining, by the computer system, a transition type of the transition, the transition type selected from a horizontal transition and a vertical transition, the horizontal transition indicating that the transition is within an architectural layer of the dependency graph, the vertical transition indicating that the transition crosses two adjacent architectural layers of the dependency graph;
determining, by the computer system, a blast area based on the one or more transitions; and
calculating, by the computer system, a blast radius score of the blast area based at least in part on a distance between each one of the impacted resources from the changed resource, the transition type, and a total number of the transitions.

8. The method of claim 1, further comprising:
selecting, by the computer system, test cases from a database connected to the computer system, based on a predetermined mapping between the impacted resources and the test cases;
triggering execution of the selected test cases for testing the application in a pre-production environment;
receiving, in the computer system, test results from the execution of the selected test cases;
analyzing, by the computer system, the test results to determine a pass rate, the pass rating indicating a percentage of the executed test cases that meet a predetermined threshold for the impacted resources; and
generating, by the computer system, a test result summary including the pass rate.

9. The method of claim 1, further comprising:
obtaining, by the computer system, a predetermined cost for the resources according to the dependency graph; and
determining, by the computer system, a change cost estimate for the change based on the predetermined cost for the resources and the impacted resources.

10. The method of claim 1, further comprising:
determining, by the computer system, whether deployment of application is allowed or blocked, based at least in part on the change impact summary.

11. A computer system comprising:
one or more processors; and
a computer-readable storage media storing computer-executable instructions, wherein, the instructions when executed by the one or more processors, cause the computer system to:
receive a dependency graph associated with an application or an update to the application for deployment in a target environment, the dependency graph indicating resources within the target environment and dependency relationships among the resources;
identify a change in resources caused by the application and one or more impact paths from the dependency graph, each one of the impact paths indicating one or more changed resources associated with the application and one or more impacted resources originating from the one or more changed resources across the dependency graph;
generate a change impact summary, the change impact summary indicating the one or more impact paths; and
output, by the computer system, the change impact summary.

12. The computer system of claim 11, wherein the instructions when executed by the one or more processors further cause the computer system to:
determine a centrality measure for each one of the impacted resources, the centrality measure selected from at least one of degree centrality, betweenness centrality, and closeness centrality;
assign an impact weight to each one of the impacted resources based on the centrality measures; and
calculate an impact propagation speed of the change along the impact path 8 through the dependency graph.

13. The computer system of claim 12, wherein the instructions when executed by the one or more processors further cause the computer system to:
determining a dependency type for each one of the impacted resources based on the dependency relationship between the impacted resource and the changed resource, the dependency types selected from a direct dependency, an indirect dependency, and a circular dependency; and
refine the impact weight assigned to each one of the impacted resources based on at least in part on the dependency type.

14. The computer system of claim 11, wherein the instructions when executed by the one or more processors further cause the computer system to:
determine the shortest impact path and the longest impact path of the one or more impacted paths.

15. The computer system of claim 12, wherein the instructions when executed by the one or more processors further cause the computer system to:
assign a risk weight to each one of the impacted resources based at least on the centrality measure of the impacted resource; and
calculate a risk estimate for the change based on the risk weight assigned to each one of the impacted resources.

16. The computer system of claim 15, wherein the instructions when executed by the one or more processors further cause the computer system to:
receive chaos testing results of the application;
determine a resilience measure for each one of the impacted resources based on the chaos testing results;
refine the risk weight for each one of the impacted resources based on the resilience measure; and
update the risk estimate for the change based on the refined risk weight.

17. The computer system of claim 11, wherein the instructions when executed by the one or more processors further cause the computer system to:
identify one or more transitions in each one of the impacted paths,
determine a transition type of the transition, the transition type selected from a horizontal transition and a vertical transition, the horizontal transition indicating that the transition is within an architectural layer of the dependency graph, the vertical transition indicating that the transition crosses two adjacent architectural layers of the dependency graph;
determine a blast area based on the one or more transitions; and
calculate a blast radius score of the blast area based at least in part on a distance between each one of the impacted resources from the changed resource, the transition type, and a total number of the transitions.

18. The computer system of claim 11, wherein the instructions when executed by the one or more processors further cause the computer system to:
select test cases from a database connected to the computer system, based on a predetermined mapping between the impacted resources and the test cases;
trigger execution of the selected test cases for testing the application in a pre-production environment;
receive test results from the execution of the selected test cases;
analyze the test results to determine a pass rate, the pass rating indicating a percentage of the executed test cases that meet a predetermined threshold for the impacted resources; and
generate a test result summary including the pass rate.

19. The computer system of claim 11, wherein the instructions when executed by the one or more processors further cause the computer system to:
obtain a predetermined cost for the resources according to the dependency graph; and
determine a change cost estimate for the change based on the predetermined cost for the resources and the impacted resources.

20. The computer system of claim 11, wherein the instructions when executed by the one or more processors further cause the computer system to:
determine whether deployment of application is allowed or blocked, based at least in part on the change impact summary.
